(19) United States
(12) Patent Application Publication
(10) Pub. No.: US 2004/0252114 A1
(43) Pub. Date: Dec. 16, 2004

(54) Power supply system for flat panel display and method for the same

(76) Inventor: Steve Lin, Yungho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/458,685

(22) Filed: Jun. 11, 2003

(51) Int. Cl. G09G 5/00

(52) U.S. Cl. 345/211

(57) ABSTRACT

A power supply system for flat panel display and method for the same is proposed to solve the problem of direct current (DC) power supply for flat panel display. The flat panel display is connected to a host computer via a connection cable. Two ends of the connection cable are connected with a DC power source input terminal of the flat panel display and a DC power source output terminal of the host computer, respectively. In the power supply method, the host computer directly provides a DC power to the flat panel display. Thereby, an external adaptor or an built-in power supply of the flat panel display can be eliminated.

### BACKGROUND OF THE INVENTION

1. Field of the Invention

The present invention relates to a power supply system for a flat panel display and a method for the same and, more particularly, to a system for providing a direct current (DC) power source to a flat panel display and a method for the same.

2. Description of Related Art

In a conventional cathode ray tube (CRT) display monitor, electrons are excited by an internal high-voltage electron gun of 25,000 volts. These electrons are accelerated by several grids to strike a screen with a layer of fluorescent material coated thereon. The fluorescent material then gives out fluorescent light after these electrons impact. According to differences of the coated fluorescent material and the magnitude of electron energy, different colors and brightness can be generated.

In order to avoid interaction between internal components of the CRT display monitor and external terrestrial magnetism so that electrons shot out by the high-voltage electron gun can fall upon appropriate positions on the screen and avoid color deviation, a demagnetization is generally performed when the CRT display monitor is turned on. However, the instantaneous power of the demagnetization is very large, about 300-400 W. The CRT display monitor also ordinarily dissipates about 100 W power. Therefore, the CRT display monitor has the drawbacks with regard to very large power consumption and bulky size.

Due to the advantages of low power dissipation and compact size, flat panel displays have gradually replaced the conventional CRT display monitors to become the mainstream product. Among flat panel displays, liquid crystal displays (LCD) are the most commonly used. Power source connections for LCD can be divided into an external type and a built-in type.

As shown in FIG. 1, an LCD 1 is connected to an external adaptor 2. The adaptor 2 is used to convert an input alternating current (AC) power source into an output DC power source. A connector at one end of the adaptor 2 plugs in a common electrical socket. The other end of the adaptor 2 is connected to the LCD 1. That is, the LCD 1 in FIG. 1 gets its DC power from the external adaptor 2.

As shown in FIG. 2, a power supply 3 is built into the LCD 1. The power supply 3 is externally connected to a connection plug that plugs into a common electric socket, which inputs an AC power source to the power supply 3. The power supply 3 then converts the input AC power source into a DC power source usable for internal circuits of the LCD 1. That is, the LCD 1 in FIG. 2 gets its DC power from the built-in power supply 3.

However, no matter whether the LCD 1 gets its DC power in an external or built-in manner, the adaptor 2 or the power supply 3 is required to convert the AC power source into a DC power source usable by the LCD 1, hence causing an increase in cost. Moreover, it is necessary to take various kinds of safety specifications (e.g., CE, UL and TUV) into consideration for the LCD 1 with the external adaptor 2 or the built-in power supply 3, hence resulting in difficulty in product design. Furthermore, desktop space is congested by the LCD 1 with the external adaptor 2, or the thickness of the LCD 1 with the built-in power supply 3 increases.

Accordingly, the above external adaptor or built-in power supply of an LCD has inconveniences and drawbacks in practical use. The present invention aims to solve the problems in the prior art.

### SUMMARY OF THE INVENTION

The primary object of the present invention is to provide a power supply system for a flat panel display and a method for the same. Because a flat panel display dissipates a much lower power than a CRT display monitor, and a demagnetization needs not be performed, it is thus not necessary to have an external adaptor or an built-in power supply to get DC power. The flat panel display can directly get its DC power from a host computer instead.

To achieve the above object, the present invention provides a power supply system for a flat panel display, which comprises a flat panel display having a DC power source input terminal, a host computer having a DC power source output terminal, and a connection cable connected between the DC power source input terminal of the flat panel display and the DC power source output terminal of the host computer.

### BRIEF DESCRIPTION OF THE DRAWINGS

The various objects and advantages of the present invention will be more readily understood from the following detailed description when read in conjunction with the appended drawings, in which:

FIG. 1 is a diagram illustrating a liquid crystal display connected with an external adaptor;

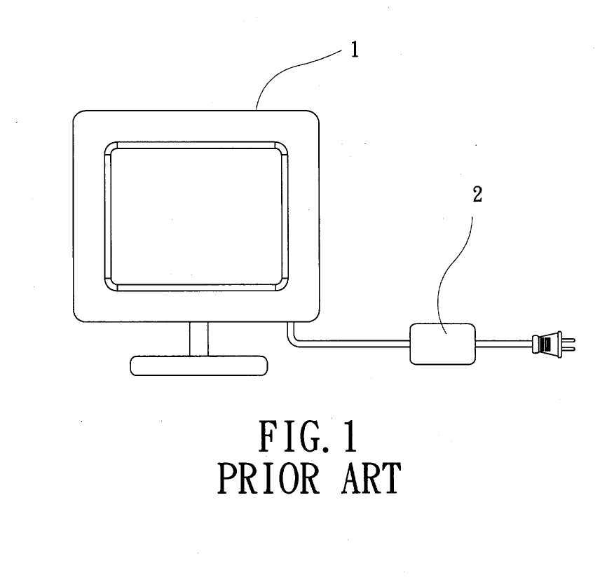

FIG. 2 is a diagram illustrating a power supply built into a liquid crystal display; and

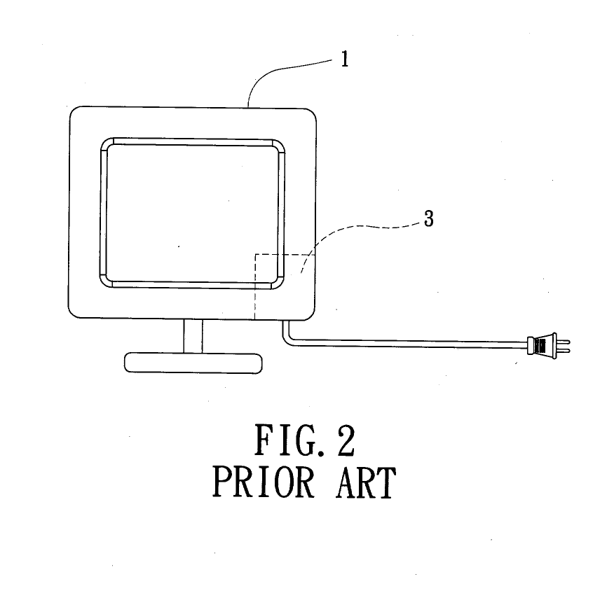

FIG. 3 is a diagram illustrating a flat panel display connected to a host computer according to a preferred embodiment of the present invention.

### DESCRIPTION OF THE PREFERRED EMBODIMENTS

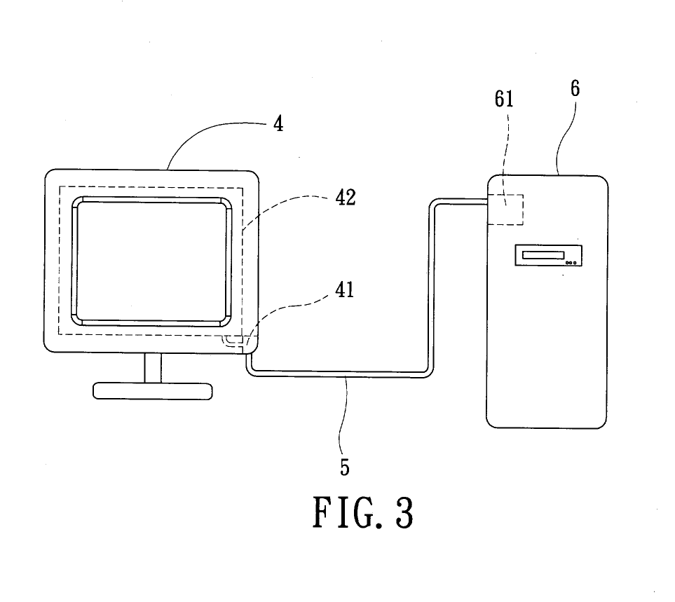

As shown in FIG. 3, which illustrates a preferred embodiment of the present invention. A flat panel display 4 dissipates less power than a CRT display monitor, and on average dissipates only several tens of watts. The flat panel display 4 of the present invention can be a compact and energy-saving display like an LCD, an organic-electro luminescence (OEL) display or an organic light-emitting diode (OLED) display.

A power supply for a standard computer can provide an output power of 250-300 W or more. For common computer uses, the power provided by the power supply is more than enough, and can further be used by a flat panel display. Therefore, this embodiment of the present invention provides a power supply system and a method for the same, in which the flat panel display 4 is connected to a host computer 6 via a connection cable 5 so that the flat panel display 4 can directly get its DC power from the host computer 6 without the need of an external adaptor or a built-in power supply.

Two ends of the connection cable 5 are connected to a DC power source input terminal 41 of the flat panel display 4 and a DC power source output terminal 61 of the host computer 6, respectively. The DC power source output terminal 61 of the host computer 6 can be directly supplied by a power supply (not shown), and a DC power source output socket is disposed at the power supply to be used by the connection cable 5. Alternatively, the DC power source output terminal 61 can be disposed at a power source transmission card (not shown), which has power source output capability and is inserted into a slot of a motherboard. A DC power source output is provided through the electric connection between the power source transmission card and the DC power source of the motherboard. Alternatively, the motherboard or another interface card (e.g., a display card) provides a DC power for the DC power source output terminal 61. Therefore, in this embodiment, the DC power source output terminal 61 is supplied by a power supply, by an interface card inserted into a slot of a motherboard, or directly by a motherboard. The power source output terminal 61 is used as the power source of the flat panel display 4. The interface card is electrically connected with the DC power source of the motherboard to provide a DC power source output. The interface card can be a power source transmission card, a display card, or any card capable of providing a DC power source output.

The DC power source input terminal 41 disposed at the flat panel display 4 directly transfers the received DC power to an internal display module 42 for use. The DC power source input terminal 41 is directly coupled with the display module 42. It is not necessary to provide an extra power supply in the flat panel display 4 to directly obtain a DC power source.

In this embodiment, the flat panel display 4 directly gets its DC power from the host computer 6 without the need of an external adaptor or a built-in power supply. Therefore, the cost of an external adaptor or a built-in power supply can be saved for the flat panel display 4. Moreover, when the internal power supply of the host computer 6 is used as the DC power source output terminal 61, because the power supply used by the host computer 6 has been checked for relevant safety specifications before leaving the factory, a stable DC power output can be provided. Therefore, it is not necessary to take the design of safety specifications into account in the manufacturing process of the flat panel display 4, hence effectively shortening the manufacturing time and cost.

To sum up, the power supply system for a flat panel display and a method for the same of the present invention have the following characteristics:

(1) A connection cable connects a flat panel display with a host computer so that the flat panel display can directly gets its DC power from the host computer.

(2) The cost and design difficulty of an external adaptor or a built-in power supply can be saved for the flat panel display, which gets its DC power directly from the host computer.

Although the present invention has been described with reference to the preferred embodiments thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A power supply system, comprising:
a flat panel display having a direct current (DC) power source input terminal;
a host computer having a DC power source output terminal; and
a connection cable connecting said DC power source input terminal with said DC power source output terminal.

2. The power supply system as claimed in claim 1, wherein said flat panel display is a liquid crystal display, an organic-electro luminescence display, or an organic light-emitting diode display.

3. The power supply system as claimed in claim 1, wherein said DC power source output terminal is disposed on a power supply of said host computer.

4. The power supply system for a flat panel display as claimed in claim 1, wherein said DC power source output terminal is disposed on a motherboard of said host computer.

5. The power supply system as claimed in claim 4, wherein an interface card is inserted into a slot of said motherboard, said interface card has said DC power source output terminal, and said DC power source output terminal is electrically connected with a DC power source of said motherboard.

6. The power supply system as claimed in claim 5, wherein said interface card is a power source transmission card or a display card.

7. A flat panel display used to connect a DC power source output terminal of a host computer, said flat panel display comprising:
a display module; and
a DC power source input terminal coupled with said display module and connected with a connection cable, another end of said connection cable being connected to said DC power source output terminal of said host computer so that the DC working voltage of said flat panel display is obtained from said host computer.

8. The flat panel display as claimed in claim 7, wherein said flat panel display is a liquid crystal display or an organic-electro luminescence display.

9. A power supply method comprising the steps of:
providing a flat panel display;
providing a host computer; and
providing a DC power to said flat panel display via said host computer.

10. The power supply method as claimed in claim 9, wherein said flat panel display is a liquid crystal display or an organic-electro luminescence display.

11. The power supply method as claimed in claim 9, wherein the DC power is transmitted from said host computer to said flat panel display via a connection cable.
